(19) United States
(12) Patent Application Publication
(10) Pub. No.: US 2007/0220563 A1
(43) Pub. Date: Sep. 20, 2007

(54) Method and apparatus for media sharing

(75) Inventor: Chi Kong Wu, Tsuen Wan (HK)

Correspondence Address: TROUTMAN SANDERS LLP, 600 PEACHTREE STREET , NE, ATLANTA, GA, 30308, US

(73) Assignee: Hong Kong Applied Science and Technology Research Institute Company Limited, Shatin (HK)

(21) Appl. No.: 11/366,341

(22) Filed: Mar. 2, 2006

(51) Int. Cl. H04N 7/18; G06F 3/00

(52) U.S. Cl. 725/81; 715/751

(57) ABSTRACT

Aspects of the present invention relate to methods, apparatuses, systems and computer program products for media sharing. One aspect of the present invention provides a method for sharing content stored on one or more content storing devices coupled to a content sharing apparatus. At least one of the content storing devices comprises a non-UPnP-enabled device. The method comprises the steps of automatically generating or updating an aggregated representation of content stored on the one or more content storing devices coupled to the media sharing apparatus upon detection of coupling of a content storing device to the media sharing apparatus, and enabling sharing of the content by one or more content retrieval devices coupled to the content sharing apparatus. The method may comprise the further step of categorizing the content stored in the content storing devices coupled to the media sharing apparatus.

### FIELD OF THE INVENTION

The present invention relates generally to content sharing and more particularly to sharing of content stored on UPnP-enabled and non-UPnP-enabled (legacy) devices.

### BACKGROUND

Examples of media sharing include playback of a movie recorded by a camcorder on a television set and viewing of a picture taken by a friend with a digital camera or a mobile telephone on a personal computer (PC).

Universal Plug and Play (UPnP) is a set of computer network protocols promulgated by the UPnP Forum. The goals of UPnP are to allow devices to connect seamlessly and to simplify the implementation of networks in the home and corporate environments. UPnP achieves this by defining and publishing UPnP device control protocols built upon open, Internet-based communication standards. UPnP is distinct from Plug-and-Play, a technology for dynamically attaching devices to a computer directly.

Legacy devices use traditional connectivity (e.g., Universal Serial Bus (USB), Bluetooth and FireWire), as opposed to UPnP to communicate with other devices. As a consequence, media sharing using legacy source and destination devices is not generally straightforward for an average user. Typically, a user has to install software on a PC before connecting and/or synchronizing a source device such as a digital camera to the PC using a standard or proprietary cable for downloading content to the PC's hard disk. Then, a software application such as Windows Media Services may be activated to facilitate video streaming or for uploading digital photos to an online photo-sharing website. Finally, the user forwards link information to friends to enable them to locate the shared content. Such networked devices, sharing software and websites require manual setup, which frequently requires detailed technical and configuration knowledge. The proliferation of legacy source and destination devices exacerbates the situation, particularly for the average home user.

Accordingly, a need exists for improved methods and apparatuses that facilitate sharing of content stored on UPnP-enabled and non-UPnP-enabled (legacy) devices.

### SUMMARY

Aspects of the present invention relate to methods, apparatuses, systems and computer program products for media sharing.

An aspect of the present invention provides a method for sharing content stored on one or more content storing devices coupled to a content sharing apparatus. At least one of the content storing devices comprises a non-UPnP-enabled device. The method comprises the steps of automatically generating or updating an aggregated representation of content stored on said one or more content storing devices coupled to the media sharing apparatus upon detection of coupling of a content storing device to the media sharing apparatus, and enabling sharing of the content by one or more content retrieval devices coupled to the content sharing apparatus.

The method may comprise the further step of categorizing the content stored in the content storing devices coupled to the media sharing apparatus.

In certain embodiments, the method comprises the further step of establishing a communications tunnel for coupling at least one of the content retrieval devices to the media sharing apparatus. Unauthorized retrieval of content stored on the content storing devices coupled to the media sharing apparatus may be prevented and the communications in the tunnel may be encrypted.

Another aspect of the present invention provides a media sharing apparatus comprising at least one interface for coupling non-UPnP-enabled content storing devices to the apparatus, a memory unit for storing data and instructions to be performed by a processing unit, and a processing unit coupled to the memory unit and the at least one interface. The processing unit is programmed to automatically generate or update an aggregated representation of content stored on one or more content storing devices coupled to the media sharing apparatus upon detection of coupling of a content storing device, and enable sharing of the content by one or more content retrieval devices coupled to the media sharing apparatus.

Another aspect of the present invention provides a media sharing system. The media sharing system comprises a media sharing apparatus, a first UPnP relay for use with the media sharing apparatus and a second UPnP relay for use with a content retrieval device. The media sharing apparatus comprises at least one interface for coupling non-UPnP-enabled content storing devices to the apparatus, a memory unit for storing data and instructions to be performed by a processing unit, and a processing unit coupled to the memory unit and the at least one interface. The processing unit is programmed to automatically generate or update an aggregated representation of content stored on one or more content storing devices coupled to the media sharing apparatus upon detection of coupling of a content storing device, and enable sharing of the content by one or more content retrieval devices coupled to the media sharing apparatus. The first and second UPnP relays are adapted to establish a communications tunnel between the media sharing apparatus and the content retrieval device.

The first and second UPnP relays may be adapted to prevent unauthorized content retrieval devices from accessing content stored on content storing devices coupled to the media sharing apparatus.

The first and second UPnP relays may be adapted to encrypt and decrypt communications in the tunnel.

The tunnel typically comprises a virtual private network (VPN).

Another aspect of the present invention provides a computer program product comprising a computer readable medium comprising a computer program recorded therein for sharing content stored on one or more content storing devices coupled to a content sharing apparatus, wherein at least one of the content storing devices comprises a non-UPnP-enabled device. The computer program product comprises computer program code means for automatically generating or updating an aggregated representation of content stored on said one or more content storing devices coupled to the media sharing apparatus upon detection of coupling of a content storing device to the media sharing apparatus, and computer program code means for enabling sharing of the content by one or more content retrieval devices coupled to the content sharing apparatus.

### BRIEF DESCRIPTION OF THE DRAWINGS

A small number of embodiments are described hereinafter, by way of example only, with reference to the accompanying drawings in which:

FIG. 1 is a block diagram of a system for media sharing in accordance with an embodiment of the present invention;

FIG. 2 is a block diagram of a system for media sharing in accordance with another embodiment of the present invention;

FIG. 3 is an architectural block diagram of a media sharing apparatus in accordance with an embodiment of the present invention;

FIG. 4 is an architectural block diagram of a Hardware Abstraction Layer (HAL) of the media sharing apparatus of FIG. 3;

FIG. 5 is an architectural block diagram of a File System Layer of the media sharing apparatus of FIG. 3;

FIG. 6 is a sequence diagram of a method for content aggregation when a UPnP-enabled device is connected to a media sharing apparatus in accordance with an embodiment of the present invention;

FIG. 7 is an architectural block diagram of a UPnP relay in accordance with an embodiment of the present invention;

FIG. 8 is a sequence diagram of a method for retrieving content from a UPnP-enabled device connected to a media sharing apparatus via a tunnel formed by a pair of UPnP relays in accordance with an embodiment of the present invention; and

FIG. 9 is a schematic block diagram of a computer system with which embodiments of the present invention may be practised.

### DETAILED DESCRIPTION

Embodiments of methods, apparatuses, systems and computer program products are described hereinafter for media sharing. Certain of the embodiments described enabled non-UPnP-enabled devices to effectively be converted into UPnP-enabled devices, thus requiring zero or minimum configuration by a user. Embodiments described hereinafter refer to legacy devices having Universal Serial Bus (USB), Bluetooth and FireWire connectivity/interfaces. However, it is not intended that the present invention be limited in this manner as any other non-UPnP-enabled connectivity/interface types may also be catered for.

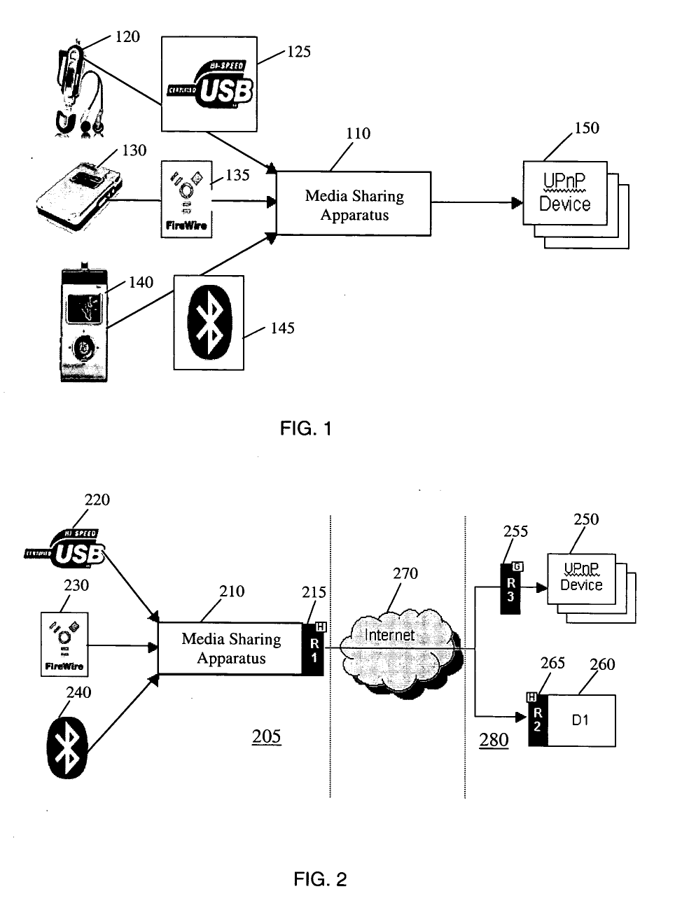

FIG. 1 is a block diagram of a system for media sharing that may comprise a single Local Area Network (LAN).

Referring to FIG. 1, a media sharing apparatus 110 is shown coupled to legacy (non-UPnP-enabled) content storing devices 120, 130 and 140 via standard Universal Serial Bus (USB) 125, FireWire 135 and Bluetooth 145 interfaces, respectively. All of the legacy content storing devices 120, 130 and 140 need not be coupled to the media sharing apparatus 110, neither simultaneously nor at any time. The media sharing apparatus 110 is also coupled to a UPnP content retrieval device 150.

When one of the legacy content storing devices 120, 130 and 140 is coupled to the media sharing apparatus 110 by a user, the media sharing apparatus 10 detects the newly-coupled legacy content storing device and “mounts” the device as a removable mass storage device. Thereafter, the media sharing apparatus 110 reads the content structure of the newly-coupled legacy content storing device 120, 130 or 140, categorizes the content stored on the legacy content storing device 120, 130 or 140 and adds the content to a category tree or content directory of the media sharing apparatus 110. An audio-visual (AV) server (not shown in FIG. 1), which forms part of the media sharing apparatus 110, is alerted and notifies all the UPnP devices coupled to the LAN (e.g., UPnP content retrieval device 150) of the change in available content. Although FIG. 1 shows a single content retrieval device 150, multiple content retrieval devices may be practiced, which are able to share the content stored on content storing devices coupled to the media sharing apparatus 110.

FIG. 2 is a block diagram of a system for media sharing that comprises multiple LANs.

Referring to FIG. 2, a media sharing apparatus 210 is shown coupled to a Universal Serial Bus (USB) interface 220, a FireWire interface 230 and a Bluetooth interface 240 for coupling of legacy content storing devices (not shown) to the media sharing apparatus 210. The media sharing apparatus 210 is coupled to a UPnP relay 215, via which the media sharing apparatus 210 is coupled to the Internet 270. The media sharing apparatus 210, the USB interface 220, the FireWire interface 230, the Bluetooth interface 240 and the UPnP relay 215 comprise a first LAN 205.

A UPnP content retrieval device 250 is coupled to the media sharing apparatus 210 via a UPnP relay 255, the Internet 270 and the UPnP relay 215. Another UPnP content retrieval device 260 is also coupled to the media sharing apparatus 210 via a UPnP relay 265, the Internet 270 and the UPnP relay 215. The UPnP-content retrieval device 250, the UPnP relay 255, the UPnP content retrieval device 260 and the relay 265 together comprise a second LAN 280. The first and second LANs 205 and 280 are coupled via the Internet 270.

Different transport modes may be used for media sharing between the media sharing apparatus 210 and the UPnP content retrieval devices 250 and 260. Irrespective of the particular transport mode, the media on the various source devices are shared as described with reference to FIG. 1. The embodiment of FIG. 2 uses the TCP/IP protocol and a proprietary message format for communication between the UPnP relay 215 and the UPnP relays 255 and 265. However, those skilled in the relevant art will readily appreciate that various different protocols and message formats may alternatively be practiced.

A host-to-host transport mode is utilized for media sharing between the media sharing apparatus 210 and the UPnP content retrieval device 260. In this mode, the LANs 205 and 280 are coupled via the UPnP relays 215 and 265, respectively. Following a request (search message) from the UPnP content retrieval device 260 via the UPnP relay 265, the UPnP relay 215 looks up the IP address of UPnP relay 265 in a filter list to determine whether the UPnP relay 265 is authorized to form a communications tunnel with the UPnP relay 215. If so, the UPnP relay 215 negotiates authentication with the UPnP relay 265. The UPnP relay 265 sends authentication information to the UPnP relay 215 and the UPnP relay 215 determines whether the authentication is valid. If valid, the UPnP relay 215 forwards a search message from the UPnP content retrieval device 260 to the media sharing apparatus 210. A response to the search request from the media sharing apparatus 210 is relayed by the UPnP relay 215 to the UPnP relay 265 via the Internet 270 and subject to the filter list. The response is then forwarded to the UPnP content retrieval device 260 by the UPnP relay 265. Subsequent UPnP messages will be filtered or forwarded between the media sharing apparatus 210 and the UPnP content retrieval device 260, according to the filter list. UPnP messages from/to devices other than the media sharing apparatus 210 and the UPnP content retrieval device 260 will be filtered out and not forwarded. Filtering is performed by either or both of the UPnP relays 215 and 265, in accordance with their respective configurations.

A host-to-gateway transport mode is utilized for media sharing between the media sharing apparatus 210 and the UPnP content retrieval device 250. In this mode, the LANs 205 and 280 are connected via the UPnP relays 215 and 255, respectively. Following a request (search message) from the UPnP content retrieval device 250 via the UPnP relay 255, the UPnP relay 215 looks up the IP address of UPnP relay 255 in a filter list to determine whether the UPnP relay 255 is authorized to form a communications tunnel with the UPnP relay 215. If so, the UPnP relay 215 negotiates authentication with the UPnP relay 255. The UPnP relay 255 sends authentication information to the UPnP relay 215 and the UPnP relay 215 determines whether the authentication is valid. If valid, the UPnP relay 215 forwards a search message from the UPnP content retrieval device 250 to the media sharing apparatus 210. A response to the search request from the media sharing apparatus 210 is relayed by the UPnP relay 215 to the UPnP relay 255 via the Internet 270 and subject to the filter list. The response is then forwarded to the UPnP content retrieval device 250 by the UPnP relay 255. Subsequent UPnP messages will be filtered or forwarded between the media sharing apparatus 210 and the UPnP content retrieval devices 250 and 260 forming part of the LAN 280 according to the filter list. UPnP messages from/to devices other than the media sharing apparatus 210 and the content retrieval devices 250 and 260 will be filtered out and not forwarded. Filtering is performed by either or both of the UPnP relays 215 and 255, in accordance with their respective configurations.

In addition, a gateway-to-gateway mode is utilized for UPnP communications between UPnP devices on LANs 205, 280.

Although various devices in FIGS. 1 and 2 are depicted as content storing or content retrieval devices, combined content storing/content retrieval devices may also be practiced. Although FIG. 2 depicts a system comprising two LANs, those skilled in the relevant art will appreciate that any number of LANs may be practiced. Moreover, any number of content storing and/or content retrieval devices may be practiced in alternative embodiments to the embodiments depicted in FIGS. 1 and 2. Coupling of non-UPnP (legacy) content retrieval devices to the media sharing apparatus may also be practiced.

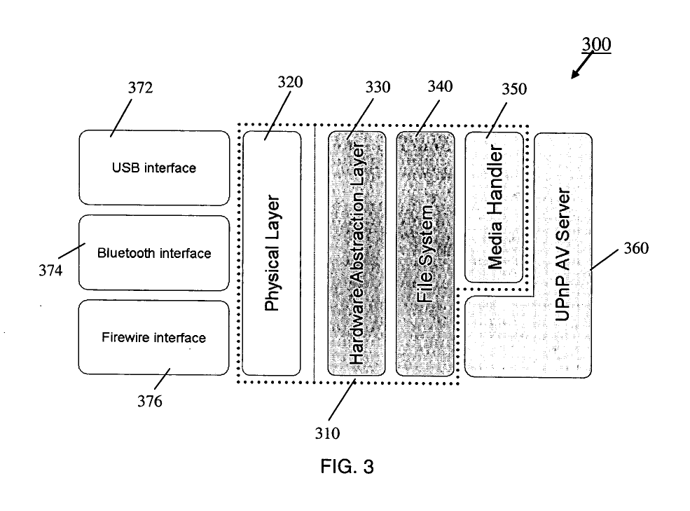

FIG. 3 is an architectural block diagram of a media sharing apparatus such as the media sharing apparatus 110 of FIG. 1 or the media sharing apparatus 210 of FIG. 2 (but without the UPnP relay 215 in FIG. 2).

Referring to FIG. 3, the media sharing apparatus 300 comprises a physical layer 320, a Hardware Abstraction Layer (HAL) 330, a file system layer 340, a media handler 350, a UPnP AV server 360 and USB, Bluetooth and FireWire interfaces 372, 374 and 376, respectively. The USB, Bluetooth and FireWire interfaces 372, 374 and 376, respectively, reside at a kernel level and the remaining components reside at a user level of the media sharing apparatus 300.

The physical layer 320, the Hardware Abstraction Layer (HAL) 330, the file system layer 340 and the media handler 350 comprise the software component 310 of the media sharing apparatus 300.

The physical layer 320 comprises the low level software routines (device drivers) for operation of the USB, Bluetooth and FireWire interfaces 372, 374 and 376, respectively. Other routines (device drivers) may simply be added to the physical layer 320 to provide operational support for other types of interfaces.

The Hardware Abstraction Layer (HAL) 330 synchronizes the input/output to the physical layer 320 and provides a unified interface to the file system layer 340. The HAL 330 handles driver-specific operations and calls corresponding routines in the physical layer 320 to perform block input/output operations.

The file system layer 340 mounts a source device when connected and notifies the media handler 350 of the new source device. The file system layer 340 provides unified input/output routine and converts file requests into logical block operations. After such conversion, the file system layer 340 calls the HAL 330 to perform the block input/output operations.

The media handler 350 categorizes the content stored in the connected source devices based on content information such as mount point, media type (e.g., movie, music, photo) and media information (e.g., author, artist, etc.). The media handler 350 also creates or alters the category tree or content directory according to the content of newly connected source devices in order to provide a category tree or content directory to the UPnP AV server 360.

The UPnP AV server 360 is a UPnP 1.0 industry-standard compliant UPnP media server, which provides a content directory service for retrieving content from connected source devices though the media handler 350. The UPnP AV server 360 additionally provides a connection manager service defined in the UPnP specification.

The various components of FIG. 3 comprise software modules or portions of software modules that may be executed by way of Application Program Interface (API) calls.

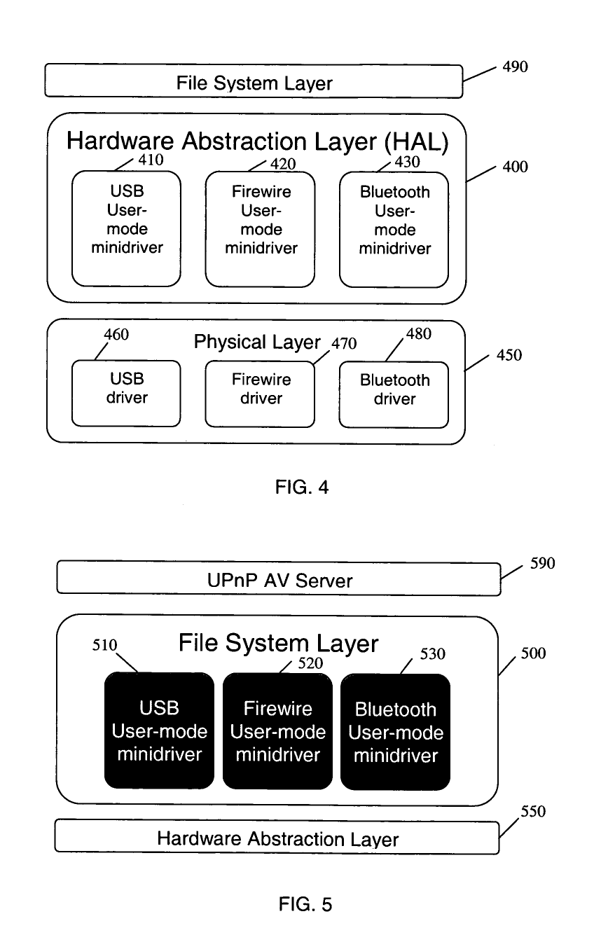

FIG. 4 is an architectural block diagram of a Hardware Abstraction Layer (HAL) and a physical layer of the media sharing apparatus 300 of FIG. 3.

Referring to FIG. 4, the HAL 400 comprises a USB user-mode mini-driver 410, a FireWire user-mode mini-driver 420 and a Bluetooth user-mode mini-driver 430. The HAL 400 is coupled to a file system layer 490 and a physical layer 450.

The physical layer 480 comprises a USB driver 460, a FireWire driver 470 and a Bluetooth driver 480 for respective USB, FireWire and Bluetooth interfaces.

The HAL 400, the file system layer 490 and the physical layer 450 are equivalent or substantially similar to the HAL 330, the file system layer 340 and the physical layer 320 of FIG. 3, respectively.

The various components of FIG. 4 comprise software modules or portions of software modules that may be executed by way of Application Program Interface (API) calls.

The structure of the HAL 400 advantageously allows the flexibility of adding new interfaces by adding associated mini-drivers without changing the software application or structure.

FIG. 5 is an architectural block diagram of a File System Layer of the media sharing apparatus of FIG. 3.

Referring to FIG. 5, the file system layer 500 comprises a USB user-mode mini-driver 510, a FireWire user-mode mini-driver 520 and a Bluetooth user-mode mini-driver 530. The file system layer 500 is coupled to a UPnP AV server 590 and a HAL 550.

The file system layer 500, the HAL 550 and the UPnP AV server 590 are equivalent or substantially similar to the file system layer 340, the HAL 330 and the UPnP AV server 360 of FIG. 3, respectively.

The various components of FIG. 5 comprise software modules or portions of software modules that may be executed by way of Application Program Interface (API) calls.

The structure of the file system layer 500 advantageously allows the flexibility of adding new interfaces by adding associated mini-drivers without changing the software application or structure.

Content Aggregation

The media sharing apparatus 300 of FIG. 3 divides media content into three categories: Movie, Music and Photo. However, other categories may be practiced in addition to or in place of the foregoing three categories. The media handler 350 categorizes the media content stored in source devices connected to the media sharing apparatus and generates or updates a content tree as the source devices are connected and/or disconnected. The content may be categorized according to the actual content information, the source device/s the content type, etc. The content tree is published by the UPnP AV server 360 using a standard UPnP AV protocol.

Each category is a folder. The media handler 350 provides three folders that are mandatory in the present embodiment, namely Movie, Music and Photo, irrespective of whether any devices are connected to the media sharing apparatus 300 or not. Each folder/category has sub-folders/sub-categories. There are two special sub-categories: All and Folders. The folder/category All lists all content that belongs to the parent category (e.g., Movie) in a flat format (i.e., there are no sub-folders/sub-categories under the folder/category All). The folder/category Folders list the names of all devices connected to the media sharing apparatus 300 that comprise the same category content. The content under a particular device name is listed in the same structure as the content stored in the actual source device. Table 1, hereinafter, shows an example of a category tree or content directory generated through music content categorization.

TABLE 1

+-Music
/ +-All
/ / +-A Hard's Day's Night.mp3
/ / +-Dr. Robert.mp3
/ / \-Yesterday.mp3
/ +-Albums
/ / +-A Hard Day's Night
/ / / \-A Hard's Day's Night.mp3
/ / \-Yesterday and Today
/ / +-Dr. Robert.mp3
/ / \-Yesterday.mp3
/ +-Artists
/ / \-The Beatles
/ / +-A Hard's Day's Night.mp3
/ / +-Dr. Robert.mp3
/ / \-Yesterday.mp3
/ +-Composers
/ +-Genres
/ / +-Classic Rock
/ / / +-A Hard's Day's Night.mp3
/ / / \-Dr. Robert.mp3
/ / \-Pop
/ / \-Yesterday.mp3
/ \-Folders
/ +-P900 (Bluetooth)
/ / \-English Songs
/ / +-A Hard's Day's Night.mp3
/ / \-Yesterday.mp3
/ \-My MP3 Player (USB)
/ \-Beatles
/ \-Dr. Robert.mp3

There are different sub-categories under each of the main categories. For example, Authors and Directors are sub-categories under the Movie main category. Albums, Artists, Composers and Genres are sub-categories under the Music main category. The sub-categories under the Photo main category may, for example, comprise data extracted from EXIF information relating to the image files (e.g., date).

If content stored on different devices belongs to same category, say the same Artists, the content will be grouped under the same category, say The Beatles, as shown in Table 1.

Table 2, hereinafter shows an example of music content categorization after connection of the legacy source device “My MP3 Player (USB)” to the media sharing apparatus 300.

TABLE 2

```
ROOT
+-Movie
| .
| .
+-Music
| .
| .
+-Photo
| .
| .
\-My MP3 Player (USB)
  +-Movie
  | +-All
  | +-Authors
  | +-Directors
  | \-Folders
  +-Music
  | +-All
  | | \-Dr. Robert.mp3
  | +-Albums
  | | \-Yesterday and Today
  | | \-Dr. Robert.mp3
  | +-Artists
  | | \-The Beatles
  | | \-Dr. Robert.mp3
  | +-Composers
  | +-Genres
  | | \-Classic Rock
  | | \-Dr. Robert.mp3
  | \-Folders
  | \-Beatles
  | \-Dr. Robert.mp3
  \-Photo
    +-All
    \-Folders
```

When a device is connected to the media sharing apparatus 300, an additional ROOT folder is added. Table 2 shows an example of a categorization tree including the source device “My MP3 Player (USB)”. The entries under the folder “My MP3 Player (USB)” relate only to the content stored on that particular device.

Appendix 1, hereinafter, shows an example of content aggregation when two source devices are connected to the media sharing apparatus 300. Table 3 of Appendix 1 shows a content structure of a camera with name “P900” connected to the media sharing apparatus 300 of FIG. 3 via Bluetooth connectivity.

Table 4 of Appendix 1 shows a content structure of a MP3 player with name “My MP3 Player” connected to the media sharing apparatus 300 of FIG. 3 via USB connectivity.

Table 5 of Appendix 1 shows an example of a content tree generated by the media sharing apparatus 300, when connected to the mobile telephone “P900” and the MP3 player “My MP3 Player”. The content structure of Table 5 is thus an aggregation of the content structures of FIGS. 3 and 4.

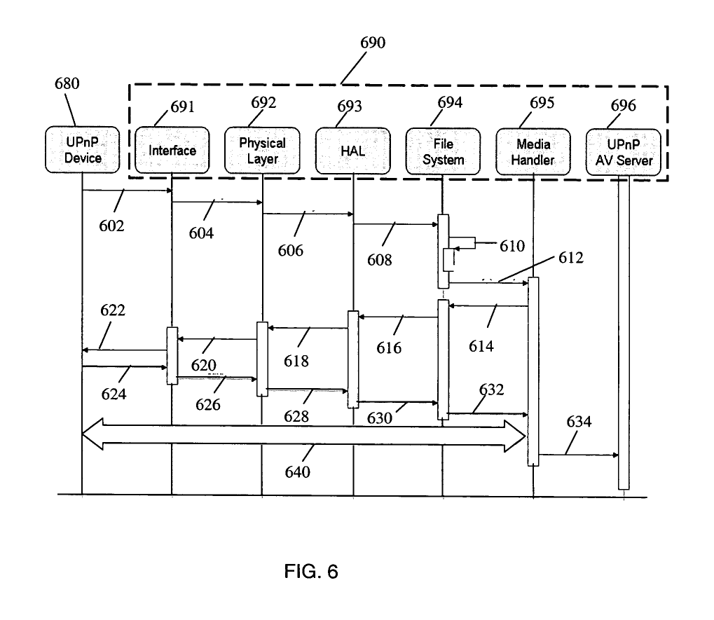

FIG. 6 is a sequence diagram of a method for content aggregation when a UPnP device is connected to a media sharing apparatus. In the embodiment described, a UPnP device 680 is connected to a media sharing apparatus 690, which is equivalent or substantially similar to the media sharing apparatus 300 of FIG. 3. The components of the media sharing apparatus 690 may be assumed to be identical to the components of the media sharing apparatus 300 in the embodiment of FIG. 3.

At step 602, an interface 691 (e.g., USB, Bluetooth or FireWire) of the media sharing apparatus 690 detects connection of the UPnP device 680.

At steps 604 to 608, the interface 691, the physical layer 692, the Hardware Abstraction Layer (HAL) 693 and the file system 694 are successively notified of connection of the UPnP device 680.

At step 610, the file system 694 mounts the UPnP device 680.

At step 612, the file system 694 notifies the media handler 695 of the mounted UPnP device 680.

The media handler 695 initiates reading of the directory of the mounted UPnP device 680 via the file system 694, the HAL 693, the physical layer 692 and the interface 691 in steps 614 to 622.

The requested data is returned to the file system 694 via the interface 691, the physical layer 692 and the Hardware Abstraction Layer (HAL) 693 in steps 624 to 630.

At step 632, the file system provides directory information to the media handler 695.

The media handler 695 forwards the directory information to the UPnP AV server 696 for insertion into an aggregated content list at step 634.

The arrow 640 is representative of subsequent content look-up operations.

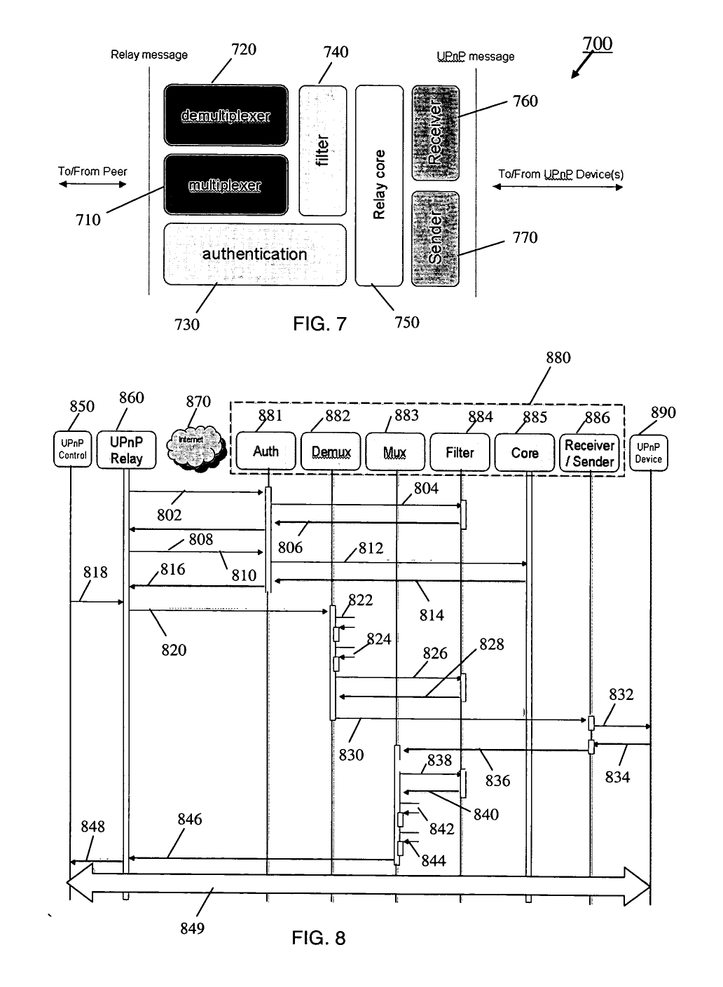

FIG. 7 is an architectural block diagram of a UPnP relay such as the UPnP relays 215, 255 and 265 of FIG. 2.

Referring to FIG. 7, the UPnP relay 700 comprises a multiplexer 710, a de-multiplexer 720, an authentication unit 730, a filter 740, a relay core 750 a sender 760 and a receiver 770.

The multiplexer 710 encrypts and multiplexes UPnP messages into a tunnel formed between a pair of UPnP relays.

The de-multiplexer 720 decrypts and de-multiplexes UPnP messages from a tunnel formed between a pair of UPnP relays.

The authentication unit 730 authenticates a remote UPnP relay by processing authentication information received from the remote UPnP relay. If authentication is successful, a tunnel is formed between the two UPnP relays, which also share a key for data encryption.

The filter 740 applies an access control list and/or filtering rules and provides UPnP message filtering at different levels (e.g., Subnet, IP address, port number, service type) for message in each direction (i.e., incoming and outgoing). The service types may include MediaServer, MediaRenderer and Internet Gateway Device.

The relay core 750 is the heart of the UPnP relay 700. It stores information relating to other UPnP relays (peers) and UPnP devices.

The sender 760 and receiver 770 handle sending and retrieval of UPnP messages to and from a connected UPnP device.

In certain embodiments of the present invention, a UPnP relay (such as the UPnP relay of FIG. 7) is integrated with a media sharing apparatus such as the media sharing apparatus 300 of FIG. 3. For example, the embodiment of FIG. 2 shows a UPnP relay 215 integrated with a media sharing apparatus 210.

FIG. 8 is a sequence diagram of a method for retrieving content from a UPnP-enabled device coupled to a media sharing apparatus via a tunnel formed by a pair of UPnP relays. In the embodiment described, a UPnP target device 890 is coupled to a media sharing apparatus (not shown but represented by UPnP-enabled control 850) via a UPnP relay 880, the Internet 870 and another UPnP relay 860. The UPnP relays 880 and 860 are equivalent or substantially similar to the UPnP relay 700 of FIG. 7. The components of the UPnP relay 880 may be assumed to be identical to the components of the UPnP relay 700 in the embodiment of FIG. 7.

At step 802, the UPnP relay 860 requests establishment of a tunnel or virtual private network (VPN) between itself and UPnP relay 880 via the Internet 870. The request is received by the authentication unit 881 of the UPnP relay 880, which checks with the filter 884 whether establishment of the tunnel is allowed or authorized.

At step 806, the filter 884 confirms to the authentication unit 881 that establishment of the tunnel is allowed.

At step 808, the authentication unit 881 specifies authentication methods to the UPnP relay 860. The UPnP relay 860 provides authentication information at step 810. When a UPnP relay wishes to communicate with another UPnP relay, the UPnP seeking to establish the tunnel provides authentication information to the other UPnP relay.

At step 812, the authentication unit 881 requests peer registration of the UPnP relay 860 to the relay core 885. The relay core 885 confirms registration to the authentication unit 881 at step 814 and the confirmation is passed on to the UPnP relay 860 at step 816. A tunnel is thus formed.

At step 818, the UPnP control 850 sends a search message to determine whether a target UPnP device exists or is available.

At step 820, the search message is encrypted and multiplexed into the tunnel by the UPnP relay 860. The search message is received and de-multiplexed at step 822 and is decrypted at step 824 by the de-multiplexer 882.

At step 826, the de-multiplexer 882 determines from the filter 884 whether the search message should be forwarded to the target UPnP device 890 or filtered. The filter 884 confirms at step 828 that the search message is to be forwarded.

At step 830, the de-multiplexer 882 requests the sender 886 to forward the search message to the target UPnP device 890. The search message is forwarded to the target UPnP device 890 by the sender 886 at step 832.

At step 834, the target UPnP device 890 replies to the search message. The reply message is forwarded to the multiplexer 883 by the receiver 886, at step 836. At step 838, the multiplexer 883 determines from the filter 884 whether the reply message should be forwarded to the UPnP control 850 or filtered. The filter 884 confirms at step 840 that the reply message is to be forwarded.

At steps 842 and 844, the reply message is encrypted and multiplexed, respectively, by the multiplexer 883. The encrypted and multiplexed reply message is forwarded to the UPnP relay 860 at step 846.

At step 848, the reply message is de-multiplexed, decrypted and forwarded to the UPnP control 850, subject to filter checking.

Subsequent messages are transferred between the UPnP control 850 and the UPnP target device 890 are passed through the pair of UPnP relays 860 and 880, as shown by arrow 849.

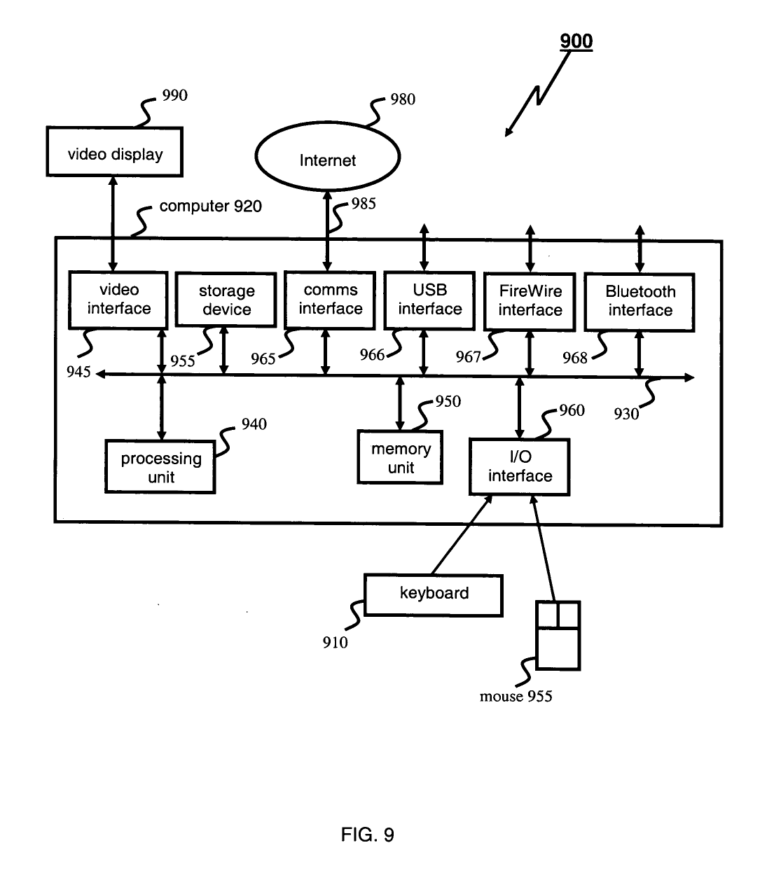

The media sharing apparatus and/or relay apparatus of embodiments of the present invention may be practiced as dedicated hardware or may be practiced as a dongle or a software application adapted to be executed by a general purpose computer system, such as the computer system 900 described hereinafter with reference to FIG. 9.

FIG. 9 is a schematic block diagram of a computer system 900 that can be used to practice the methods described herein. More specifically, the computer system 900 is provided for executing computer software that is programmed to assist in performing a method for UPnP media sharing. The computer software executes under an operating system such as MS Windows 2000™, MS Windows XP™, MS Windows CE or Linux™ installed on the computer system 900.

The computer software involves a set of programmed logic instructions that may be executed by the computer system 900 for instructing the computer system 900 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code, that perform particular steps of the methods described hereinbefore.

The components of the computer system 900 comprise: a computer 920, input devices 910, 915 and a video display 990. The computer 920 comprises: a processing unit 940, a memory unit 950, an input/output (I/O) interface 960, a communications interface 965 (e.g., a serial interface), a Universal Serial Bus (USB) interface 966, a FireWire interface 966, a Bluetooth interface 967, a video interface 945, and a storage device 955. The computer 920 may comprise more than one of any of the foregoing units, interfaces, and devices.

The processing unit 940 may comprise one or more processors that execute the operating system and the computer software executing under the operating system. The memory unit 950 may comprise random access memory (RAM), read-only memory (ROM), flash memory and/or any other type of memory known in the art for use under direction of the processing unit 940.

The video interface 945 is connected to the video display 990 and provides video signals for display on the video display 990. User input to operate the computer 920 is provided via the input devices 910 and 915, comprising a keyboard and a mouse, respectively. The storage device 955 may comprise a disk drive or any other suitable non-volatile storage medium.

Each of the components of the computer 920 is connected to a bus 930 that comprises data, address, and control buses, to allow the components to communicate with each other via the bus 930.

The computer system 900 may be connected to one or more other similar computers via the communications interface 965 using a communication channel 985 to a network 980, represented as the Internet.

USB, FireWire and/or Bluetooth devices may be connected or coupled to the computer system 900 via the Universal Serial Bus (USB) interface 966, the FireWire interface 966 and the Bluetooth interface 967, respectively.

The computer software program may be provided as a computer program product, and recorded on a portable storage medium. In this case, the computer software program is accessible by the computer system 900 from the storage device 955. Alternatively, the computer software may be accessible directly from the network 980 by the computer 920. In either case, a user can interact with the computer system 900 using the keyboard 910 and mouse 915 to operate the programmed computer software executing on the computer 920. Software updates for downloading to coupled UPnP and legacy devices may also be obtained via the network 980 by the computer 920.

The computer system 900 has been described for illustrative purposes. Accordingly, the foregoing description relates to an example of a particular type of computer system such as a personal computer (PC), which is suitable for practicing the methods and computer program products described hereinbefore. Those skilled in the computer programming arts would readily appreciate that alternative configurations or types of computer systems may be used to practice the methods and computer program products described hereinbefore.

In one particular embodiment, the media sharing apparatus and/or relay apparatus described hereinbefore is practiced using an embedded computer system running a real-time operating system (RTOS) such as Linux™ or VxWork™. The embedded computer system is similar to the computer system 900 of FIG. 9 but may exclude certain unnecessary components such as the video display 990, keyboard 910 and mouse 955. In this instance, the media sharing apparatus and/or relay apparatus may be configured via a web interface and the communications interface 965. A remote control may be interfaced to the media sharing apparatus and/or relay apparatus via the Input/Output interface 960.

A small number of embodiments of methods, systems, apparatuses and computer program products have been described hereinbefore for UPnP media sharing. Advantageously, the embodiments described hereinbefore enable sharing of content stored on legacy devices having industry-standard interfaces such as Bluetooth, FireWire and Universal Serial Bus (USB) without the need for proprietary cables or software installation. As the media sharing apparatus and (optional) relay of embodiments described herein effectively convert legacy devices into UPnP-enabled devices upon connection or coupling, the minimum or zero configuration requirements associated with UPnP-enabled devices can be exploited when legacy devices are connected or coupled. Content aggregation and sharing is performed automatically by the media sharing apparatus upon connection or coupling of a legacy device (i.e., at runtime) with zero or minimum configuration required by a user. In particular, embodiments of the present invention do not require software installation and/or media copying for accessing content stored on legacy devices. Content sharing between UPnP and legacy source and destination devices advantageously enables easy content searching and look-up. Use of the UPnP relays described hereinbefore advantageously enlarge the sharing space beyond a single LAN and enable protection of content via access control (e.g., filtering) and encryption.

The embodiments described hereinbefore support media files with digital rights management (DRM) and provide security when media sharing occurs across the Internet (or any other public or private network). Such security includes authentication between relays, encryption of traffic between relays and blocking of incoming connection requests and/or messages at a host and/or service level.

Embodiments of the present invention are applicable to, and may be practiced in, various industries, including the home appliance industry and the industrial electronics industry. Examples of particular products embodiments of the present invention may be applied to or practiced in conjunction with include, but are not limited to, printers, scanners, cameras, mobile telephones, MP3 players and personal digital assistants (PDAs).

The foregoing description provides exemplary embodiments only, and is not intended to limit the scope, applicability or configurations of the present invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter. Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

[Australia Only]

The term “comprising” (and its grammatical variations such as “comprises” and “is comprised of”) as used herein is used in the inclusive sense of “having” or “including” and not in the exclusive sense of “consisting only of”.

### Appendix 1

TABLE 3

```
P900
+-English Songs
| +-A Hard's Day's Night.mp3
| \-Yesterday.mp3
+-Party
| \-Drunk.jpg
\-Xmas2005
  +-Gift Exchange.mpg
  +-GiftExchange.jpg
  \-XmasTree.jpg
A Hard's Day's Night.mp3
- artist: The Beatles
- album : A Hard's Day's Night
- genres: Classic Rock
Yesterday.mp3
- artist: The Beatles
- album : Yesterday and Today
- genres: Pop
```

TABLE 4

My MP3 Player
\-Beatles
\-Dr. Robert.mp3
Dr. Robert.mp3
- artist: The Beatles
- album : Yesterday and Today
- genres: Classic Rock

TABLE 5

```
ROOT
+-Movie
| +-All
| | \-Gift Exchange.mpg
| +-Authors
| +-Directors
| \-Folders
| \-P900 (Bluetooth)
| \-Xmas2005
| \-Gift Exchange.mpg
+-Music
| +-All
| | +-A Hard's Day's Night.mp3
| | +-Dr. Robert.mp3
| | \-Yesterday.mp3
| +-Albums
| | +-A Hard Day's Night
| | | \-A Hard's Day's Night.mp3
| | \-Yesterday and Today
| | +-Dr. Robert.mp3
| | \-Yesterday.mp3
| +-Artists
| | \-The Beatles
| | +-A Hard's Day's Night.mp3
| | +-Dr. Robert.mp3
| | \-Yesterday.mp3
| +-Composers
| +-Genres
| | +-Classic Rock
| | | +-A Hard's Day's Night.mp3
| | | \-Dr. Robert.mp3
| | \-Pop
| | \-Yesterday.mp3
| \-Folders
| +-P900 (Bluetooth)
| | \-English Songs
| | +-A Hard's Day's Night.mp3
| | \-Yesterday.mp3
| \-My MP3 Player (USB)
| \-Beatles
| \-Dr. Robert.mp3
+-Photo
| +-All
| | +-Drunk.jpg
| | +-GiftExchange.jpg
| | \-XmasTree.jpg
| \-Folders
| \-P900 (Bluetooth)
| +-Party
| | \-Drunk.jpg
| \-Xmas2005
| +-GiftExchange.jpg
| \-XmasTree.jpg
+-P900 (Bluetooth)
| +-Movie
| | +-All
| | |\-Gift Exchange.mpg
| | +-Authors
| | +-Directors
| | \-Folders
| | \-Xmas2005
| | \-Gift Exchange.mpg
| +-Music
| | +-All
| | | +-A Hard's Day's Night.mp3
| | | \-Yesterday.mp3
| | +-Albums
| | | +-A Hard Day's Night
| | | | \-A Hard's Day's Night.mp3
| | | \-Yesterday and Today
| | | \-Yesterday.mp3
| | +-Artists
| | | \-The Beatles
| | | +-A Hard's Day's Night.mp3
| | | \-Yesterday.mp3
| | +-Composers
| | +-Genres
| | | +-Classic Rock
| | | | \-Yesterday.mp3
| | | \-Pop
| | | \-A Hard's Day's Night.mp3
| | \-Folders
| | \-English Songs
| | +-A Hard's Day's Night.mp3
| | \-Yesterday.mp3
| \-Photo
| +-All
| \-Folders
| +-Party
| | \-Drunk.jpg
| \-Xmas2005
| +-GiftExchange.jpg
| \-XmasTree.jpg
\-My MP3 Player (USB)
  +-Movie
  | +-All
  | +-Authors
  | +-Directors
  | \-Folders
  +-Music
  | +-All
  | | \-Dr. Robert.mp3
  | +-Albums
  | | \-Yesterday and Today
  | | \-Dr. Robert.mp3
  | +-Artists
  | | \-The Beatles
  | | \-Dr. Robert.mp3
  | +-Composers
  | +-Genres
  | | \-Classic Rock
  | | \-Dr. Robert.mp3
  | \-Folders
  | \-Beatles
  | \-Dr. Robert.mp3
  \-Photo
    +-All
    \-Folders
```

I claim:

1. A method for sharing content stored on one or more content storing devices coupled to a content sharing apparatus, wherein at least one of said content storing devices comprises a non-UPnP-enabled device, said method comprising the steps of:
automatically generating or updating an aggregated representation of content stored on said one or more content storing devices coupled to said media sharing apparatus, upon detection of coupling of a content storing device to said media sharing apparatus; and
enabling sharing of said content by one or more content retrieval devices coupled to said content sharing apparatus.

2. The method of claim 1, comprising the further step of categorizing the content stored in the content storing devices coupled to said media sharing apparatus.

3. The method of claim 2, wherein said categorization is based on one or more criteria selected from the group of criteria consisting of the actual content information, the content type, and the content storing device type.

4. The method of claim 3, comprising the further step of publishing the aggregated content representation using a standard UPnP AV protocol.

5. The method of claim 1, wherein at least one of said content retrieval devices comprises a UPnP-enabled device.

6. The method of claim 5, comprising the further step of establishing a communications tunnel for coupling at least one of said content retrieval devices to said media sharing apparatus.

7. The method of claim 6, comprising the further step of performing access control to prevent unauthorized content retrieval devices from accessing content stored on content storing devices coupled to said media sharing apparatus.

8. The method of claim 6, comprising the further step of encrypting and decrypting communications in said tunnel.

9. A media sharing apparatus, comprising:
at least one interface for coupling non-UPnP-enabled content storing devices to said apparatus;
a memory unit for storing data and instructions to be performed by a processing unit; and
a processing unit coupled to said memory unit and said at least one interface, said processing unit programmed to:
automatically generate or update an aggregated representation of content stored on one or more content storing devices coupled to said media sharing apparatus, upon detection of coupling of a content storing device; and
enable sharing of said content by one or more content retrieval devices coupled to said media sharing apparatus.

10. The media sharing apparatus of claim 9, wherein said processing unit is further programmed to categorize the content stored in the content storing devices coupled to said media sharing apparatus.

11. The media sharing apparatus of claim 10, wherein said categorization is based on one or more criteria selected from the group of criteria consisting of the actual content information, the content type, and the content storing device type.

12. The media sharing apparatus of claim 11, wherein said processing unit is further programmed to publish the aggregated content representation using a standard UPnP AV protocol.

13. The media sharing apparatus of claim 9, wherein at least one of said content retrieval devices comprises a UPnP-enabled device.

14. The media sharing apparatus of claim 13, wherein said processing unit is further programmed to establish a communications tunnel for coupling at least one of said content retrieval devices to said media sharing apparatus.

15. The media sharing apparatus of claim 14, wherein said processing unit is further programmed to prevent unauthorized content retrieval devices from accessing content stored on content storing devices coupled to said media sharing apparatus.

16. The media sharing apparatus of claim 14, wherein said processing unit is further programmed to encrypt and decrypt communications in said tunnel.

17. The media sharing apparatus of claim 9, wherein said content storing devices comprise devices selected from the group of devices consisting of:
Universal Serial Bus (USB)-enabled devices;
FireWire-enabled devices; and
Bluetooth-enabled devices.

18. A media sharing system, comprising:
a media sharing apparatus comprising:
at least one interface for coupling non-UPnP-enabled content storing devices to said apparatus;
a memory unit for storing data and instructions to be performed by a processing unit; and
a processing unit coupled to said memory unit and said at least one interface, said processing unit programmed to:
automatically generate or update an aggregated representation of content stored on one or more content storing devices coupled to said media sharing apparatus, upon detection of coupling of a content storing device; and
enable sharing of said content by one or more content retrieval devices coupled to said media sharing apparatus;
a first UPnP relay for use with said media sharing apparatus; and
a second UPnP relay for use with a content retrieval device;
wherein said first and second UPnP relays are adapted to establish a communications tunnel between said media sharing apparatus and said content retrieval device.

19. The media sharing system of claim 18, wherein said wherein said first and second UPnP relays are adapted to prevent unauthorized content retrieval devices from accessing content stored on content storing devices coupled to said media sharing apparatus.

20. The media sharing system of claim 18, wherein said wherein said first and second UPnP relays are adapted to encrypt and decrypt communications in said tunnel.

21. The media sharing system of claim 18, wherein said tunnel comprises a virtual private network (VPN).

22. The media sharing system of claim 18, wherein said processing unit is further programmed to categorize the content stored in the content storing devices coupled to said media sharing apparatus.

23. The media sharing system of claim 18, wherein at least one of said one or more content retrieval devices comprises a UPnP-enabled device.

24. A computer program product comprising a computer readable medium comprising a computer program recorded therein for sharing content stored on one or more content storing devices coupled to a content sharing apparatus, wherein at least one of said content storing devices comprises a non-UPnP-enabled device, said computer program product comprising:
computer program code means for automatically generating or updating an aggregated representation of content stored on one or more content storing devices coupled to said media sharing apparatus, upon detection of coupling of a content storing device to said media sharing apparatus; and
computer program code means for enabling sharing of said content by one or more content retrieval devices coupled to said content sharing apparatus.

25. The computer program product of claim 24, further comprising computer program code means for categorizing the content stored in the content storing devices coupled to said media sharing apparatus.

26. The computer program product of claim 25, wherein said categorization is based on one or more criteria selected from the group of criteria consisting of the actual content information, the content type, and the content storing device type.

27. The computer program product of claim 26, further comprising computer program code means for publishing the aggregated content representation using a standard UPnP AV protocol.

28. The computer program product of claim 24, wherein at least one of said content retrieval devices comprises a UPnP-enabled device.

29. The computer program product of claim 28, further comprising computer program code means for establishing a communications tunnel via the Internet for coupling at least one of said content retrieval devices to said media sharing apparatus.

30. The computer program product of claim 29, further comprising computer program code means for performing access control to prevent unauthorized content retrieval devices from accessing content stored on content storing devices coupled to said media sharing apparatus.

31. The computer program product of claim 29, further comprising computer program code means for encrypting and decrypting communications in said tunnel.
